(19) United States
(12) Patent Application Publication
(10) Pub. No.: US 2008/0136608 A1
(43) Pub. Date: Jun. 12, 2008

(54) SENSORY EFFECTS IN A MOBILE DEVICE AND AN ACCESSORY THEREOF

(75) Inventors: Martin Guthrie, Moffat (CA); David Mak-Fan, Waterloo (CA); Joseph C. Chen, Waterloo (CA)

Correspondence Address: INTEGRAL INTELLECTUAL PROPERTY INC., 1370 DON MILLS ROAD, SUITE 300, TORONTO, ON, M3B 3N7, omitted

(73) Assignee: RESEARCH IN MOTION LIMITED, Waterloo (CA)

(21) Appl. No.: 11/609,153

(22) Filed: Dec. 11, 2006

(51) Int. Cl. G08B 27/00

(52) U.S. Cl. 340/326

(57) ABSTRACT

A file comprising control information for the production of sensory effects is stored in a mobile device. When audio information is processed to produce sound, the control information is processed to produce sensory effects that are synchronized to the sound. The sensory effects may include visual effects and/or mechanical effects.

### BACKGROUND

A mobile device may be able to process audio information that is stored in a file and to cause an audio output device to produce sound according to the audio information. The audio information contained in the file may be, for example, a song, a “ring tone” or any other audio information. The audio output device may be embedded in the mobile device (e.g. a speaker), may be electrically coupled to the mobile device (e.g. an earbud or headphones), or may be embedded in a wireless accessory of the mobile device (e.g. a wireless headset or wireless headphones).

Mobile devices and wireless accessories may comprise one or more light sources, for example light emitting diodes (LEDs). The light sources may be used to provide visual effects that complement and are synchronized to the sound that is produced from a file of audio information. The visual effects may include activation and/or deactivation of light sources, changes in the intensity of light emitted from light sources, and changes in the color of light emitted from light sources.

Mobile devices and wireless accessories may comprise vibrating elements, for example, a vibrator and/or a buzzer. The vibrating elements may be used to provide mechanical effects that complement and are synchronized to the sound that is produced from a file of audio information. The mechanical effects may include activation and/or deactivation of vibrating elements and modulation of the frequency and/or amplitude of the vibration.

The mobile device may process the audio information in the file on more than one occasion to generate control information that produces sensory effects, such as visual and/or mechanical effects. For example, the mobile device may process the audio information to generate the control information in conjunction with processing the audio information to produce sound. If the sensory effects are enabled, the mobile device may process the audio information in the file to generate the control information each time the audio information is processed to produce sound. The control information may be generated on-the-fly portion-by-portion for respective portions of the audio information. A generated portion of control information may be immediately processed by the mobile device to produce the sensory effects for the respective portion of audio information. Generated portions of control information may be overwritten by subsequent portions of control information, such that the control information is never stored in its entirety and cannot be reused.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a simplified illustration of an exemplary communication system;

FIG. 2 is a simplified block diagram of an exemplary mobile device;

FIG. 3 is a simplified block diagram of an exemplary wireless accessory;

FIG. 4 is a flowchart of a method for generating and storing in a file control information for sensory effects; and

FIG. 5 is a flowchart of a method for using a file comprising control information for sensory effects.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

In order to avoid reprocessing the same audio information to generate the same control information, the mobile device may store a file containing the control information that was previous generated by processing the audio information. For example, the control information may be used to produce sensory effects that are synchronized to a particular ring tone or to a certain song. By processing the audio information of the ring tone or song in advance, the control information may be generated and stored in a file. This may be a separate file from the file where the audio information is stored, or the audio information and control information may be stored together in the same file. The control information may be used by the mobile device to produce the sensory effects while the mobile device is processing the audio information to produce sound, for example, playing the ring tone or song. Since the control information is stored in its entirety, it may be reused on more than one occasion when the mobile device is processing the audio information to produce sound.

The sound produced may be output via an audio output element of the mobile device and/or via an audio output element of an accessory of the mobile device. The visual effects produced from the control information may be achieved by controlling one or more light sources in the mobile device and/or by controlling one or more light sources in an accessory of the mobile device. The mechanical effects produced from the control information may be achieved by controlling one or more vibrating elements in the mobile device. The control information may be hardware-dependent, for example, specific to the mobile device or specific to the accessory. Alternatively, the control information may be hardware-independent. If one or more light sources in an accessory are to be controlled to produce, at least in part, the visual effects, then appropriate signaling from the mobile device to the accessory may be involved. For example, the communications between the mobile device and the accessory may be wired or wireless.

“Controlling one or more light sources” may involve turning a light source on or off, changing the intensity of light emitted from a light source, and/or changing a color of light emitted from a light source.

“Controlling one or more vibrating elements” may involve activating and/or deactivating vibrating elements and/or modulating frequency and/or amplitude of vibrations.

The file of control information may be generated by the mobile device by processing the audio information. Alternatively, the file may be transmitted to the mobile device from a data source. That data source may be, for example, a computer to which the mobile device is coupled, or a server from which the file may be retrieved via a communication infrastructure, for example, the Internet.

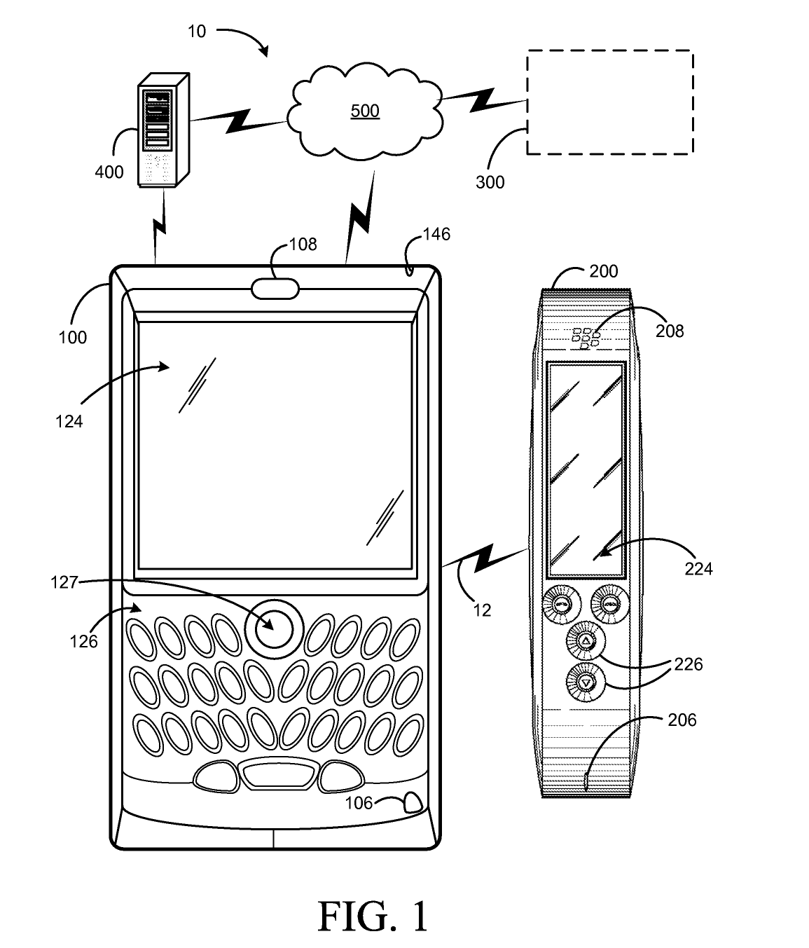

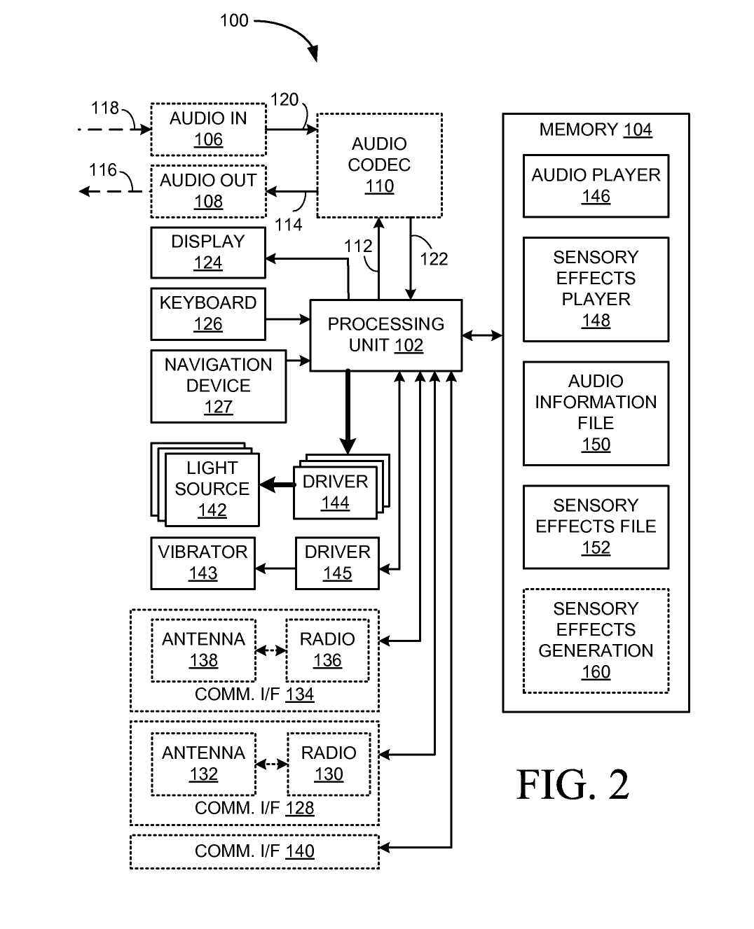

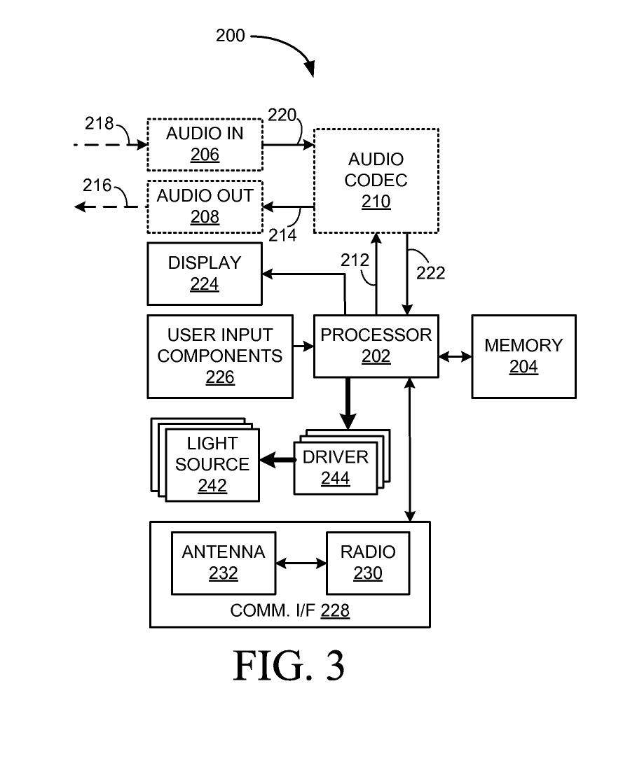

Reference is made now to FIGS. 1, 2 and 3. FIG. 1 is a simplified illustration of an exemplary communication system 10 comprising an exemplary mobile device 100, an exemplary wireless accessory 200, a system 300, a computer 400 and a communication infrastructure 500. FIG. 2 is a simplified functional block diagram of mobile device 100, and FIG. 3 is a simplified functional block diagram of wireless accessory 200. For clarity, some components and features of mobile device 100 and wireless accessory 200 are not shown in FIGS. 1, 2 and 3 and are not described explicitly below.

Communication infrastructure 500 may comprise any combination of private and/or public networks and may comprise the Internet. System 300 may comprise any combination of computers, servers and communication means, and may be able to store files and to execute applications. Computer 400 may be able to communicate with system 300 via communication infrastructure 500.

A non-exhaustive list of examples for mobile device 100 includes a cellular phone, a smart phone, a personal digital assistant (PDA), an electronic mail (Email) client, a gaming device, a laptop computer, a notebook computer, a wireless terminal, an MP3 (Moving Picture Experts Group Layer-3 Audio) player, and any other suitable mobile apparatus. A non-exhaustive list of examples for wireless accessory 200 includes a wireless headset, a wireless handset, and any other suitable wireless accessory.

Mobile device 100 comprises a processing unit 102 and a memory 104 coupled to processing unit 102. Mobile device 100 may optionally comprise an audio input element 106, for example, a microphone, an audio output element 108, for example, a speaker, and an audio coder-decoder (codec) 110. Codec 110 may be a hardware codec, a software codec or a combination thereof.

Similarly, wireless accessory 200 comprises a processing unit 202 and a memory 204 coupled to processing unit 202. Wireless accessory 200 may optionally comprise an audio input element 206, for example, a microphone, an audio output element 208, for example, a speaker, and an audio codec 210. Codec 210 may be a hardware codec, a software codec or a combination thereof.

A non-exhaustive list of examples for processing units 102 and 202 includes microprocessors, microcontrollers, central processing units (CPU), digital signal processors (DSP), reduced instruction set computers (RISC), complex instruction set computers (CISC) and the like. Furthermore, any of processing units 102 and 202 may comprise more than one processing unit, may be part of an application specific integrated circuit (ASIC) or may be a part of an application specific standard product (ASSP).

A non-exhaustive list of examples for memories 104 and 204 includes any combination of the following:

a) semiconductor devices such as registers, latches, read only memory (ROM), mask ROM, electrically erasable programmable read only memory devices (EEPROM), flash memory devices, non-volatile random access memory devices (NVRAM), synchronous dynamic random access memory (SDRAM) devices, RAMBUS dynamic random access memory (RDRAM) devices, double data rate (DDR) memory devices, static random access memory (SRAM), universal serial bus (USB) removable memory, and the like;

b) optical devices, such as compact disk read only memory (CD ROM), and the like; and

c) magnetic devices, such as a hard disk, a floppy disk, a magnetic tape, and the like.

Codec 110 (210) may be able to receive a digital representation 112 (212) of sound waves from processing unit 102 (202) and to output a corresponding analog signal 114 (214) to audio output device 108 (208). Audio output device 108 (208) may be able to receive analog signal 114 (214) and to output sound waves 116 (216) corresponding to analog signal 114 (214). In addition, audio input element 106 (206) may be able to receive sound waves 118 (218) and to output a corresponding analog signal 120 (220) to codec 110 (210). Codec 110 (210) may be able to receive analog signal 120 (220) and to output a digital representation 122 (222) of analog signal 120 (220) to processing unit 102 (202).

Mobile device 100 comprises a display 124, a keyboard 126 and a navigation device 127, all coupled to processing unit 102, and may comprise additional user interface elements that are not shown in FIGS. 1 and 2. Keyboard 126 may be embedded in full or in part within display 124, i.e. display 124 may be a “touch screen”.

Wireless accessory 200 comprises a display 224, coupled to processing unit 202, and one or more user input components 226, coupled to processor 202. Any of user input components 226 may be embedded within display 224, i.e. display 224 may be a “touch screen”. Wireless accessory 200 may comprise additional user interface elements that are not shown in FIGS. 1 and 3.

Mobile device 100 optionally comprises a communication interface 128. Communication interface 128 may be coupled to processing unit 102 and comprises at least a radio 130 and an antenna 132. Similarly, wireless accessory 200 comprises a communication interface 228. Communication interface 228 may be coupled to processing unit 202 and comprises at least a radio 230 and an antenna 232. Communication interfaces 128 and 228 are compatible with a common wireless communication standard. Handheld device 100 and wireless accessory 200 may be able to communicate with each other over a wireless communication link 12 via communication interfaces 128 and 228, respectively.

For example, mobile device 100 and wireless accessory 200 may both be “Bluetooth®-enabled”, and communication interfaces 128 and 228 may comply with Bluetooth® core specifications v1.1, published Feb. 22, 2001 by the Bluetooth® special interest group (SIG) and/or with Bluetooth® core specifications v1.2, published Nov. 5, 2003. However, it will be obvious to those of ordinary skill in the art how to modify the following for other existing Bluetooth® standards or future related standards. Alternatively, communication interfaces 128 and 228 may comply with any other suitable wireless communication standard, for example Zigbee™ or ultra wideband (UWB).

Mobile device 100 may comprise a wireless communication interface 134, compatible with a wireless communication standard that is different from the wireless communication standard that communication interface 128 is compatible with. Wireless communication interface 134 may be coupled to processing unit 102 and comprises at least a radio 136 and an antenna 138. Mobile device 100 may be able to communicate with system 300 via wireless communication interface 134 and communication infrastructure 500.

A non-exhaustive list of examples for antennae 132, 138 and 232 includes dipole antennae, monopole antennae, multilayer ceramic antennae, planar inverted-F antennae, loop antennae, shot antennae, dual antennae, omnidirectional antennae and any other suitable antennae.

A non-exhaustive list of examples for standards with which wireless communication interface 134 may comply includes Direct Sequence—Code Division Multiple Access (DS-CDMA) cellular radiotelephone communication, Global System for Mobile Communications (GSM) cellular radiotelephone, North American Digital Cellular (NADC) cellular radiotelephone, Time Division Multiple Access (TDMA), Extended-TDMA (E-TDMA) cellular radiotelephone, wideband CDMA (WCDMA), General Packet Radio Service (GPRS), Enhanced Data for GSM Evolution (EDGE), 3G and 4G communication.

Alternatively, handheld device 100 may be “802.11-enabled”, and wireless communication interface 134 may comply with one or more of the standards from the 802.11 family of standards defined by the Institute of Electrical and Electronic Engineers (IEEE) for Wireless LAN MAC and Physical layer (PHY) specifications.

Mobile device 100 may comprise a communication interface 140, compatible with a wired communication standard. Communication interface 140 may be coupled to processing unit 102. Mobile device 100 may be able to communicate with computer 400 via communication interface 140.

Mobile device 100 may comprise one or more light sources 142. Light sources 142 may be embedded in any user interface device of mobile device 100, for example, keyboard 126 or navigation device 127, or elsewhere, such as exemplary light source 146. Processing unit 102 may be able to turn any of light sources 142 on or off using drivers 144. Processing unit 102 may be able to control the color and/or the intensity of light emitted from any of light sources 142 using drivers 144.

Similarly, accessory 200 may comprise one or more light sources 242. Light sources 242 may be embedded in any of user input components 226, or elsewhere. Processing unit 202 may be able to turn any of light sources 242 on or off using drivers 244. Processing unit 202 may be able to control the color and/or the intensity of light emitted from any of light sources 242 using drivers 244.

Mobile device 100 may comprise one or more vibrating elements 143. Processing unit 102 may be able to control vibrating elements 143 using drivers 145. Processing unit 102 may be able to activate and deactivate vibrating elements 143 and may be able to modulate the frequency and/or amplitude of vibrations of vibrating elements 143.

Mobile device 100 may comprise other elements that can be discerned by human senses.

Memory 104 may store an “audio player” application module 146 and a “sensory effects player” application module 148. Modules 146 and 148 may be parts of a single application module. Memory 104 may store an audio information file 150, containing, for example, one or more songs, ring tones, and the like. Memory 104 may also store a sensory effects file 152 that contains control information for producing sensory effects that are synchronized to sound produced from audio information file 150.

The control information stored in file 152 may be pre-produced from audio information file 150 or from one or more files containing similar audio information. In one aspect, the control information may be hardware-dependent, that is, the control information may be specific to the production of sensory effects in a specific mobile device and/or a specific accessory. In another aspect, the control information may be hardware-independent.

Processing unit 102, executing audio player module 146, may process audio information file 150 to output a digital representation 112 of sound waves. The digital representation 112 is provided to audio codec 110 and results in sound being produced by audio output element 108, as described above. For example, if audio information file 150 comprises a ring tone, then the ring tone is played via a speaker of mobile device 100.

Processing unit 102, executing sensory effects module 148, may process sensory effects file 152 to produce visual effects (via drivers 144 and light sources 142) and/or mechanical effects (via drivers 145 and vibrating elements 143) that are synchronized with the sound produced by processing audio information file 150. To continue the previous example, light sources in mobile device 100 may be controlled to produce visual effects that are synchronized to the playing of the ring tone, and vibrating elements of mobile device 100 may be controlled to produce mechanical effects that are synchronized to the playing of the ring tone.

The digital representation 112 may be transmitted to wireless accessory 200 via communication interface 128 and communication interface 228. Processor 202 may provide digital representation 112 to audio codec 210 so that sound may be produced by audio output element 208, as described above. For example, if wireless accessory 200 is a wireless headset and audio information file 150 comprises a song, then the song is played via a speaker of the wireless headset. Similarly, the output of processing visual effects file 152 may be transmitted to wireless accessory 200 via communication interface 128 and communication interface 228. To continue the previous example, light sources in the wireless headset are controlled to produce visual effects that are synchronized to the playing of the song. The sound, in its entirety or portions there of, may be output by audio output elements of wireless accessory 200 in addition to, or instead of, being output by audio output elements of mobile device 100. The visual effects, in their entirety or portions thereof, may be produced by light sources of wireless accessory 200 in addition to, or instead of, being produced by light sources of mobile device 100.

Sensory effects file 152 may be generated by mobile device 100. To that end, memory 104 may store a control information generation module 160. Processing unit 102, executing generation module 160, may process audio information file 150 to generate control information for producing sensory effects that are synchronized with the sound to be produced from audio information file 150. The control information generated may be stored in sensory effects file 152.

Alternatively, sensory effects file 152 may be generated by a computing device, for example, by computer 400 or by a server in system 300, stored in the computing device, and then transmitted to mobile device 100 for storage in memory 104. In this case, the computing device is able to execute a control information generation module similar to module 160, which has been described above.

Although described as separate files, audio information file 150 and sensory effects file 152 may be in fact a single file comprising audio information and control information. In another embodiment, control information for different sensory elements, e.g. light sources 142 and vibrating elements 143, may be stored in separate files.

The visual effects may include, for example, activation and/or deactivation of light sources, changes in the intensity of light emitted from light sources, and changes in the color of light emitted from light sources. The mechanical effects may include, for example, activation and/or deactivation of vibrating elements and modulating frequency and/or amplitude of vibrations.

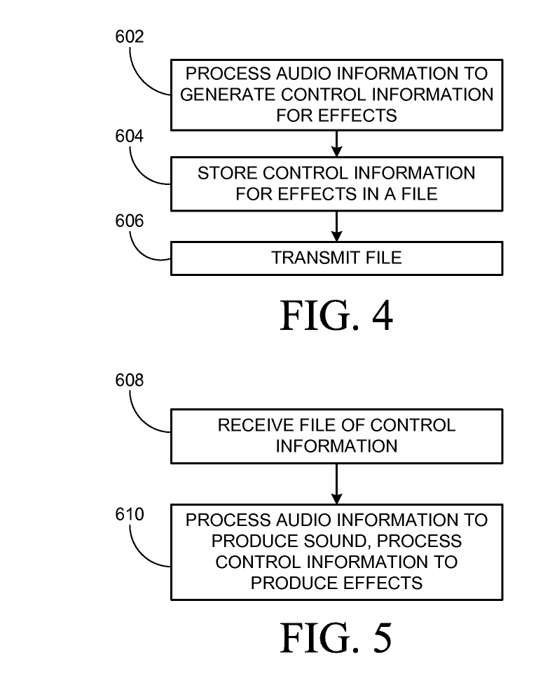

FIG. 4 is a flowchart of a method for generating and storing control information for sensory effects in a file. At 602, audio information is processed to generate control information for sensory effects that are synchronized with sound to be produced from the audio information. At 604, the control information generated at 602 is stored in a file. The file may also comprise the audio information which was processed at 602. If the method of FIG. 4 is implemented in mobile device, then the method ends after 604. If the method of FIG. 4 is implemented in a computer, for example, computer 400, or in a server of system 300, then the method continues to 606, where the file is transmitted. In the case of a computer coupled to mobile device 100, the file may be transmitted to mobile device 100 for storage therein. In the case of a server of system 300, the file may be transmitted directly to mobile device 100 for storage therein, or to a computer 400 from which it may subsequently be transmitted to mobile device 100 for storage therein.

FIG. 5 is a flowchart of a method for using a file comprising control information for sensory effects. The method of FIG. 5 may be implemented in mobile device 100. If mobile device 100 has generated the file, then the method begins at 610, where the audio information is processed to produce sound, as described above, and the control information in the file is processed to produce sensory effects that are synchronized to the sound, as described above. If mobile device 100 has not generated the control information, then the file comprising the control information is received by mobile device 100 at 608.

While certain features of the invention have been illustrated and described herein, many modifications, substitutions, changes, and equivalents will now occur to those of ordinary skill in the art. It is, therefore, to be understood that the appended claims are intended to cover all such modifications and changes.

What is claimed is:

1. A method comprising
processing audio information to generate control information for production of sensory effects that are synchronized to sound produced from said audio information; and
storing said control information in a file.

2. The method of claim 1, wherein said file further comprises said audio information.

3. The method of claim 1, further comprising:
transmitting said file via a communication infrastructure.

4. The method of claim 1, wherein said sensory effects comprise visual effects.

5. The method of claim 1, wherein said sensory effects comprise mechanical effects.

6. A method comprising
storing a file comprising control information for production of sensory effects that are synchronized to sound produced from audio information;
producing sound from said audio information; and
using said control information to produce said sensory effects in synchronization with producing said sound.

7. The method of claim 6, wherein said file further comprises said audio information.

8. The method of claim 6, further comprising:
receiving said file via a communication infrastructure.

9. The method of claim 6, wherein said sensory effects comprise visual effects and using said control information to produce said sensory effects comprises:
using said control information to produce said visual effects from one or more light sources in synchronization with producing said sound.

10. The method of claim 6, wherein said sensory effects comprise mechanical effects and using said control information to produce said sensory effects comprises:
using said control information to produce said mechanical effects from one or more vibrating elements in synchronization with producing said sound.

11. A mobile device comprising:
a processing unit;
one or more light sources able to emit light, coupled to said processing unit via drivers; and
a memory able to store a file comprising control information which, when processed by said processing unit, is arranged to produce visual effects that are synchronized to sound produced from audio information.

12. The mobile device of claim 11, wherein said file further comprises said audio information.

13. The mobile device of claim 11, wherein said memory is further able to store instructions which, when executed by said processing unit, are arranged to process said audio information to generate said control information.

14. The mobile device of claim 11, further comprising:
a communication interface through which said mobile device is able to receive said file.

15. A mobile device comprising:
a processing unit;
one or more vibrating elements sources able to create vibrations, coupled to said processing unit via drivers; and
a memory able to store a file comprising control information which, when processed by said processing unit, is arranged to produce mechanical effects that are synchronized to sound produced from audio information.

16. The mobile device of claim 15, wherein said file further comprises said audio information.

17. The mobile device of claim 15, wherein said memory is further able to store instructions which, when executed by said processing unit, are arranged to process said audio information to generate said control information.

18. The mobile device of claim 15, further comprising:
a communication interface through which said mobile device is able to receive said file.
